(19) United States
(12) Patent Application Publication
(10) Pub. No.: US 2012/0207533 A1
(43) Pub. Date: Aug. 16, 2012

(54) MARKER PEN WITH A BENDING ASSEMBLY

(75) Inventor: BAO-SHEN LIU, New Taipei City (TW)

(73) Assignees: YU-CHIA LIU, New Taipei City (TW); BAO-SHEN LIU, New Taipei City (TW)

(21) Appl. No.: 13/369,547

(22) Filed: Feb. 9, 2012

(30) Foreign Application Priority Data
Feb. 16, 2011 (CN) 201110038957.1

(51) Int. Cl. B43K 8/02

(52) U.S. Cl. 401/262; 401/261

(57) ABSTRACT

A marker pen has a penholder, a bending assembly and a writing part. The bending assembly is mounted on the penholder and includes a bending angle, a first section and a second section. The first section and the second section are connected with each other. The first section is connected to the penholder. The writing part is made of fibers being able to contain ink, is mounted through the bending assembly and is inserted in the penholder. Therefore, it is convenient for a user to hold the marker pen in the hand to meet different situations and the user's line of sight to the writing area is not obscured.

### BACKGROUND OF THE INVENTION

1. Field of the Invention

The present invention relates to a marker pen, and more particularly to a marker pen with a bending assembly for practical use.

2. Description of the Prior Arts

A marker pen is used to make a mark or to draw a picture. A conventional marker pen is straight and is held in a user's hand when being used. However, the user must hold the marker pen in non-ergonomic positions to meet different situations, which might cause inconvenience or injury to the user. The following are examples of different use situations.

With reference to FIG. 1, when the user uses the marker pen T1 to write on an upper vertical surface, the marker pen T1 will be held in an inclined position, which causes backflow of ink inside the marker pen T1 in the direction of an arrow S1 and thus affects writing smoothness.

With reference to FIG. 2, when the user uses the marker pen T1 to write on a lower vertical surface, the user's wrist must be unnaturally cocked with respect to the forearm in the direction of arrows S2 and thus causes discomfort to the wrist.

With reference to FIG. 3, when a child uses the marker pen (e.g. a color pen) T1 to draw a picture, the child cannot hold the marker pen T1 properly because children's skeletons are still developing. Holding the marker pen T1 improperly results in that the child's line of sight Q1, Q2 is obscured by the hand and the point of the marker pen T1 and causes a poor light writing area S3. Besides, it is difficult to correct the pen-holding posture of the child who gets used to holding a pen improperly.

With reference to FIG. 4, it clearly shows that the centerlines W1, W2, W3, W4 of gaps between the adjacent digits of a human hand are radial rather than parallel to each other, which causes inconvenience of holding a straight object to humans. With reference to FIG. 5, the user often must hold the marker pen T1 in non-ergonomic positions to meet different situations, which causes backflow of ink inside the marker pen T1 in the direction of the arrow S1 and results in that the user's wrist is unnaturally cocked in the direction of arrows S2.

To overcome the shortcomings, the present invention provides a marker pen with a bending assembly to mitigate or obviate the aforementioned problems.

### SUMMARY OF THE INVENTION

The main object of the present invention is to provide a marker pen with a bending assembly that is convenient to be held in a user's hand to meet different situations.

To achieve the foregoing objective, the marker pen in accordance with the present invention comprises a penholder, a bending assembly and a writing part. The bending assembly is mounted on the penholder and includes a bending angle, a first section and a second section. The first section and the second section are connected with each other. The first section is attached to the penholder. The writing part is made of fibers being able to contain ink, is mounted through the bending assembly and is inserted in the penholder. Therefore, it is convenient for a user to hold the marker pen in the hand to meet different situations and the user's line of sight to the writing area is not obscured.

Other objectives, advantages and novel features of the invention will become more apparent from the following detailed description when taken in conjunction with the accompanying drawings.

### BRIEF DESCRIPTION OF THE DRAWINGS

FIGS. 1 to 3 are operational perspective views of a conventional marker pen in accordance with the prior art;

FIG. 4 is a perspective view of a human hand;

FIG. 5 is an operational perspective view of the conventional marker pen in accordance with the prior art;

FIG. 6 is an exploded side view in partial section of a first embodiment of a marker pen in accordance with the present invention;

FIG. 7 is a side view in partial section of the first embodiment of the marker pen in FIG. 6;

FIG. 8 is an enlarged side view in partial section of the first embodiment of the marker pen in FIG. 6;

FIG. 9 is a side view of the first embodiment of the marker pen in FIG. 6;

FIGS. 10 to 13 are operational perspective views of the first embodiment of the marker pen in FIG. 6;

FIG. 14 is a side view of a second embodiment of the marker pen in accordance with the present invention;

FIG. 15 is an enlarged side view in partial section of a third embodiment of the marker pen in accordance with the present invention;

FIG. 16 is an enlarged side view in partial section of a fourth embodiment of the marker pen in accordance with the present invention;

FIG. 17 is an enlarged side view in partial section of a fifth embodiment of the marker pen in accordance with the present invention;

FIG. 17A is a front view of the fifth embodiment of the marker pen in FIG. 17;

FIG. 18 is a partial side view of the fifth embodiment of the marker pen in accordance with the present invention showing that notches of a first section are open;

FIG. 18A is a partial enlarged view of the fifth embodiment of the marker pen in FIG. 18;

FIG. 19 is a partial side view of the fifth embodiment of the marker pen in accordance with the present invention showing that the notches of the first section are closed;

FIG. 19A is a partial enlarged view of the fifth embodiment of the marker pen in FIG. 19;

FIG. 20 is a side view of the fifth embodiment of the marker pen in accordance with the present invention;

FIG. 21 is an enlarged side view in partial section of a sixth embodiment of the marker pen in accordance with the present invention;

FIG. 22 is a side view of the sixth embodiment of the marker pen in accordance with the present invention;

FIG. 23 is a cross-sectional side view of a pen cap of a seventh embodiment of the marker pen in accordance with the present invention;

FIG. 23A is a front view in partial section of the pen cap of the seventh embodiment of the marker pen along line a1-a2 in FIG. 23;

FIG. 24 is a side view of the seventh embodiment of the marker pen in accordance with the present invention;

FIG. 25 is a side view of an eighth embodiment of the marker pen in accordance with the present invention;

FIG. 26 is an exploded side view in partial section of a ninth embodiment of the marker pen in accordance with the present invention;

FIG. 27 is a side view in partial section of the ninth embodiment of the marker pen in FIG. 26;

FIG. 28 is a side view of the ninth embodiment of the marker pen in accordance with the present invention showing that a third section is screwed away from the first section;

FIG. 29 is a side view of the ninth embodiment of the marker pen in accordance with the present invention showing that the third section is screwed toward the first section;

FIG. 30 is an exploded side view of a tenth embodiment of the marker pen in accordance with the present invention without the pen cap;

FIG. 31 is a cross-sectional side view of the tenth embodiment of the marker pen in FIG. 30;

FIG. 32 is a side view of the tenth embodiment of the marker pen in accordance with the present invention;

FIG. 33 is a cross-sectional side view of an eleventh embodiment of the marker pen in accordance with the present invention without the pen cap;

FIG. 33A is a front view in partial section of the eleventh embodiment of the marker pen along line J1-J2 in FIG. 33;

FIG. 34 is a side view of the eleventh embodiment of the marker pen in accordance with the present invention;

FIG. 34A is a front view of the eleventh embodiment of the marker pen in FIG. 34;

FIG. 35 is a cross-sectional side view of a twelfth embodiment of the marker pen in accordance with the present invention;

FIG. 36 is a side view of a thirteenth embodiment of the marker pen in accordance with the present invention without the pen cap;

FIG. 36A is a front view of the thirteenth embodiment of the marker pen in FIG. 36;

FIG. 37 is a cross-sectional side view of the thirteenth embodiment of the marker pen in accordance with the present invention; and

FIG. 38 is a cross-sectional side view of a fourteenth embodiment of the marker pen in accordance with the present invention.

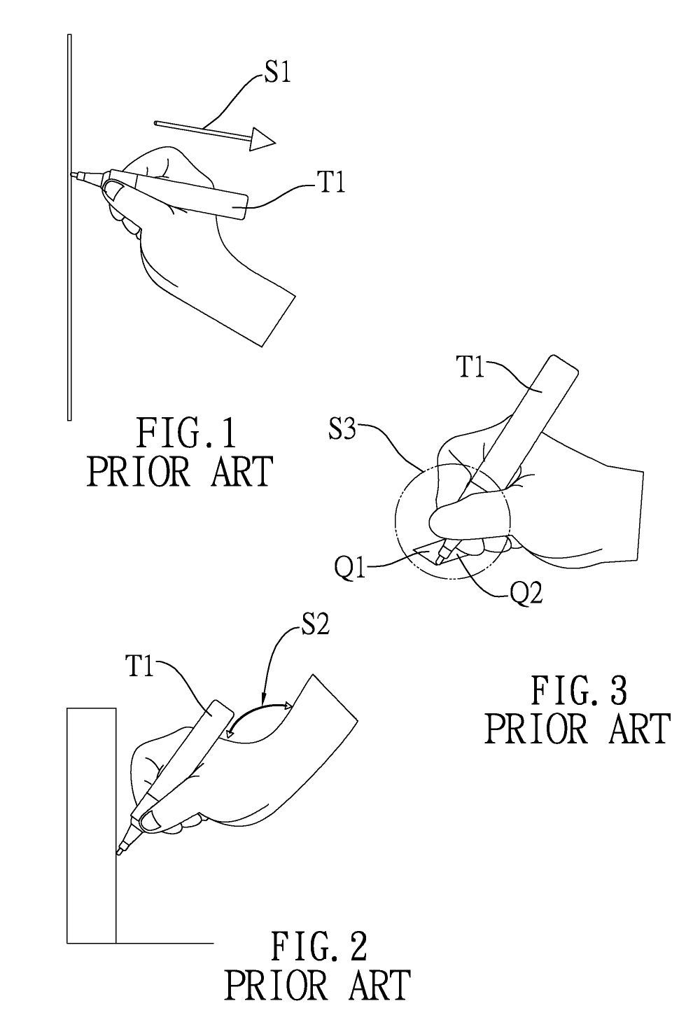

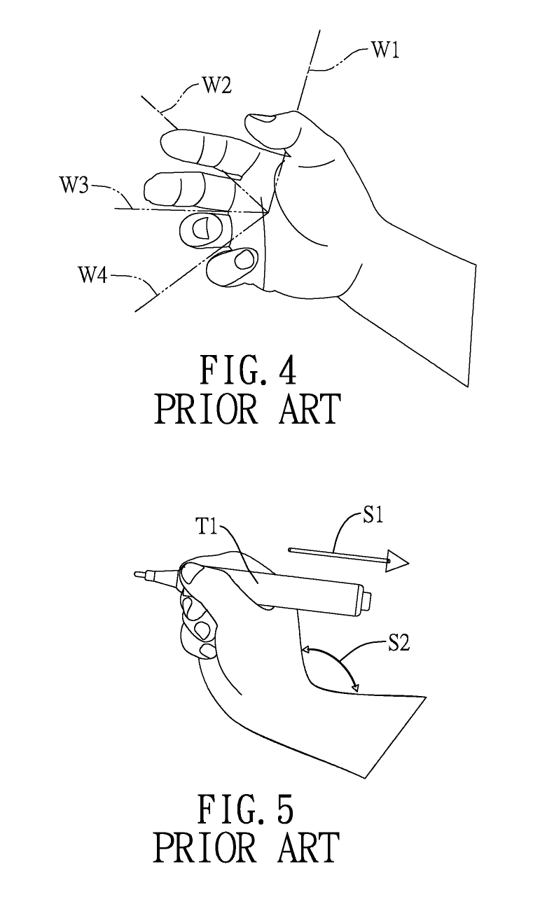

### DETAILED DESCRIPTION OF THE PREFERRED EMBODIMENTS

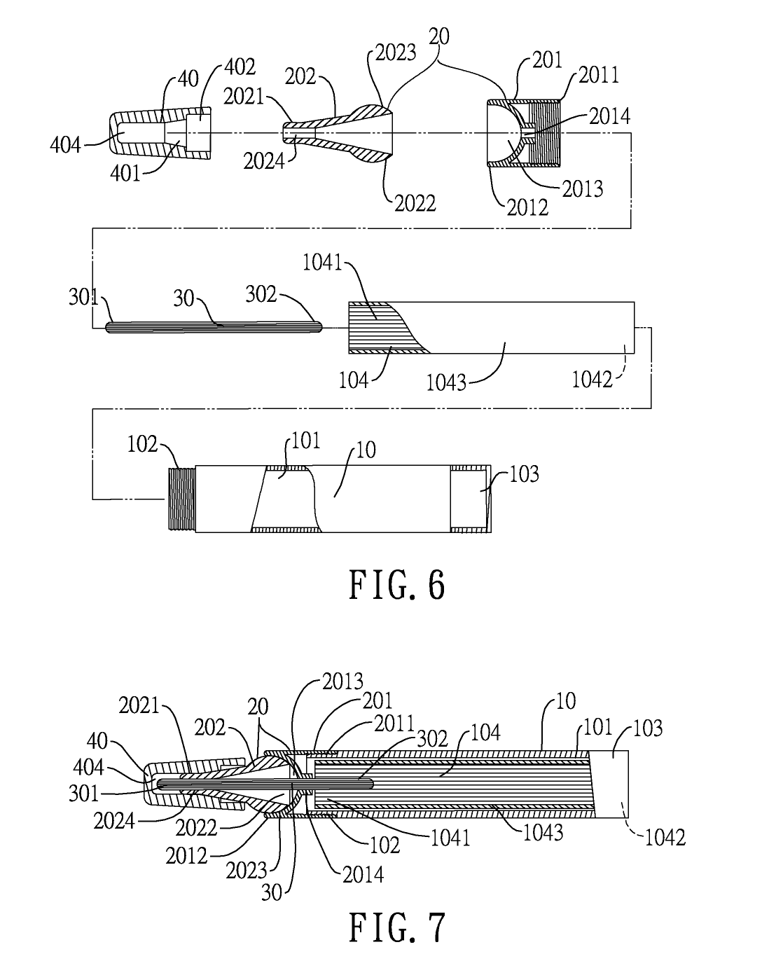

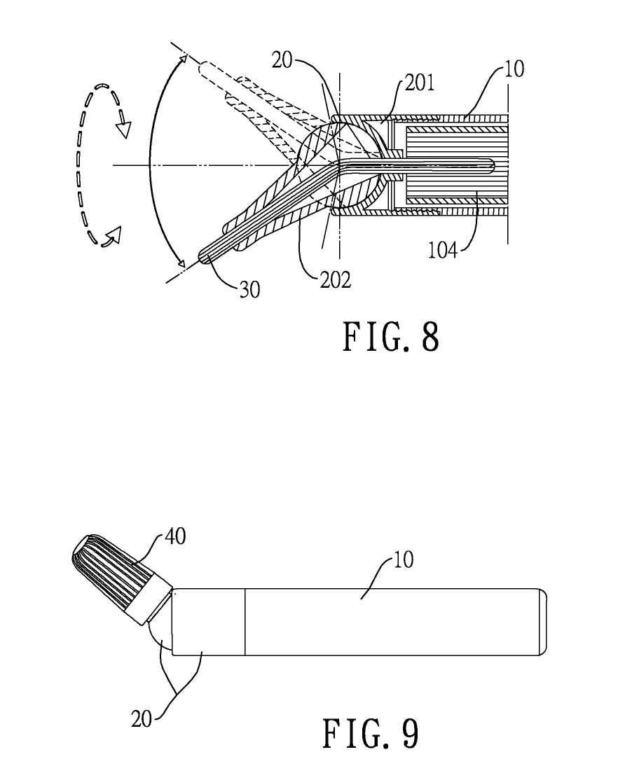

With reference to FIGS. 6 to 9, a marker pen in accordance with the present invention comprises a penholder 10, a bending assembly 20, a writing part 30 and a pen cap 40.

The penholder 10 includes a tube and an ink reservoir. The tube has a hollow interior 101, a first end 102 and a second end 103. The first end 102 of the tube is an open end. The ink reservoir is disposed in the hollow interior 101 of the tube.

The bending assembly 20 is mounted on the penholder 10 and includes a bending angle, a first section 201 and a second section 202. The first section 201 and the second section 202 are connected with each other. The first section 201 is attached to the penholder 10.

The writing part 30 is mounted through the bending assembly 20, is made of flexible fibers being able to contain ink, is elongated and includes a head end 301 and an insert end 302. The head end 301 protrudes out of the second section 202 of the bending assembly 20. The insert end 302 is inserted in the penholder 10 and is connected to the ink reservoir for leading ink to the head end 301.

The pen cap 40 is detachably connected to the second section 202 of the bending assembly 20 and covers the head end 301 of the writing part 30 for preventing the writing part 30 from drying out when the marker pen is not in use. The pen cap 40 includes a receiving space having an open portion 402, a middle portion 401 and a closed portion 404. The closed portion 404 of the receiving space allows the head end 301 of the writing part 30 to be received therein.

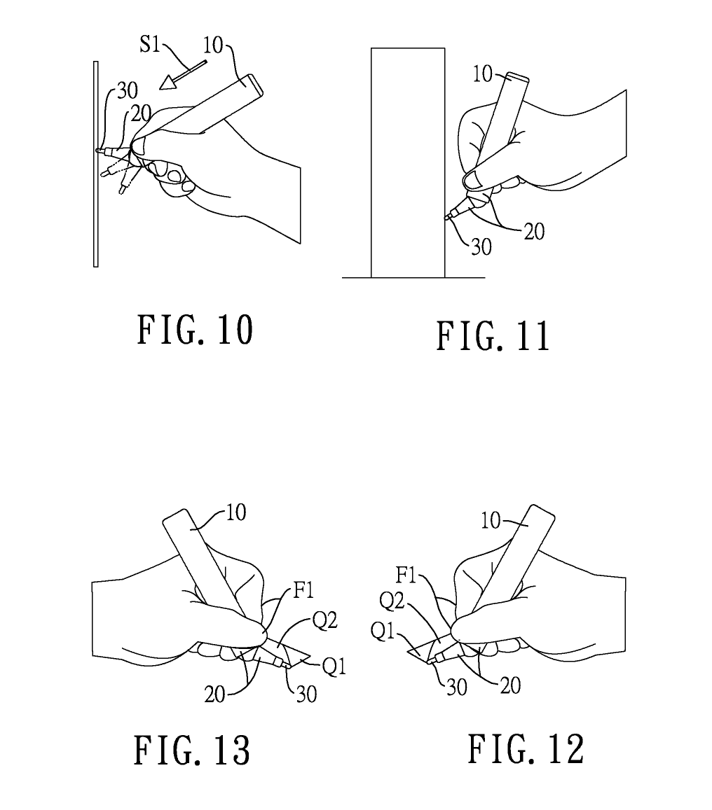

With the bending assembly 20, an angle is formed between the penholder 10 and the writing part 30. Therefore, a user can hold the marker pen in ergonomic positions to meet different situations and the user's line of sight to the writing area is not obscured. With reference to FIGS. 10 and 11, when the user uses the marker pen to write on a vertical surface, the marker pen is convenient to be held in the user's hand, which does not cause backflow of ink inside the marker pen and excessive bending of the user's wrist. With reference to FIG. 12, when a child uses the marker pen to draw a picture, the child's digits F1 can hold the penholder 10 stably and do not slide to the writing part 30, thus providing the child with good line of sight Q1, Q2. With reference to FIG. 13, the marker pen can also be used conveniently for left-handed users.

With reference to FIGS. 6 to 9, in a first embodiment, the second end 103 of the tube of the penholder 10 is a closed end and the ink reservoir of the penholder 10 is a fiber bunch 104. The fiber bunch 104 is able to contain ink and has two ends 1041, 1042. The insert end 302 of the writing part 30 is inserted in one end 1041 of the fiber bunch 104. A jacket 1043 that is made of a plastic material encloses the fiber bunch 104.

The first section 201 and the second section 202 of the bending assembly 20 are made of a plastic material and are connected via a curve-shaped concave-convex structure. In a preferred embodiment, the first section 201 has a first end 2011, a second end 2012, a recess 2013 and a first passage 2014. The first end 2011 of the first section 201 is secured to the first end 102 of the tube of the penholder 10. The recess 2013 is formed in the second end 2012 of the first section 201. The recess 2013 is ball-shaped and has a recess open end, a recess closed end, a ball radius and a ball diameter. A distance from the recess open end to the recess closed end is greater than the ball radius. A diameter of the recess open end is less than the ball diameter. The first passage 2014 is formed through the first section 201 and extends from the first end 2011 to the recess 2013 of the first section 201.

The second section 202 has a first end 2021, a second end 2022, a projection 2023 and a second passage 2024. The projection 2023 is formed on the second end 2022 of the second section 202. The projection 2023 is ball-shaped and corresponds to and is rotatably mounted in the recess 2013 of the first section 201. Therefore, the second section 202 can be rotated in three-dimensional space relative to the first section 201 and the bending angle is formed between the first section 201 and the second section 202. The second passage 2024 is formed through the second section 202, extends from the first end 2021 to the second end 2022 of the second section 202 and aligns with the first passage 2014 of the first section 201. The writing part 30 is mounted through the first and second passages 2014, 2024 of the bending assembly 20.

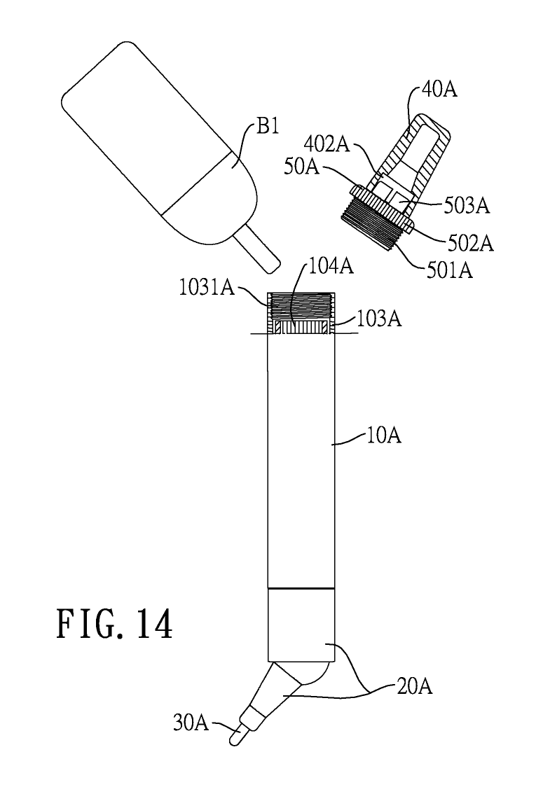

With reference to FIG. 14, in a second embodiment based on the first embodiment, the second end 103A of the tube of the penholder 10A is an open end having an internal thread 1031A. An end cover 50A having an external thread 501A is screwed into the internal thread 1031A of the second end 103A. Therefore, an ink bottle B1 can be used to supply ink to the ink reservoir of the penholder 10A when the end cover 50A is detached from the penholder 10A. Further, the end cover 50A has a flange 502A and at least one protrusion 503A. The flange 502A is provided with a rough peripheral surface to improve the frictional characteristics so that the end cover 50A can be easily attached to or detached from the penholder 10A. The open portion 402A of the receiving space of the pen cap 40A can be mounted on the at least one protrusion 503A of the end cover 50A when the marker pen is in use, thereby preventing the pen cap 40A from being lost.

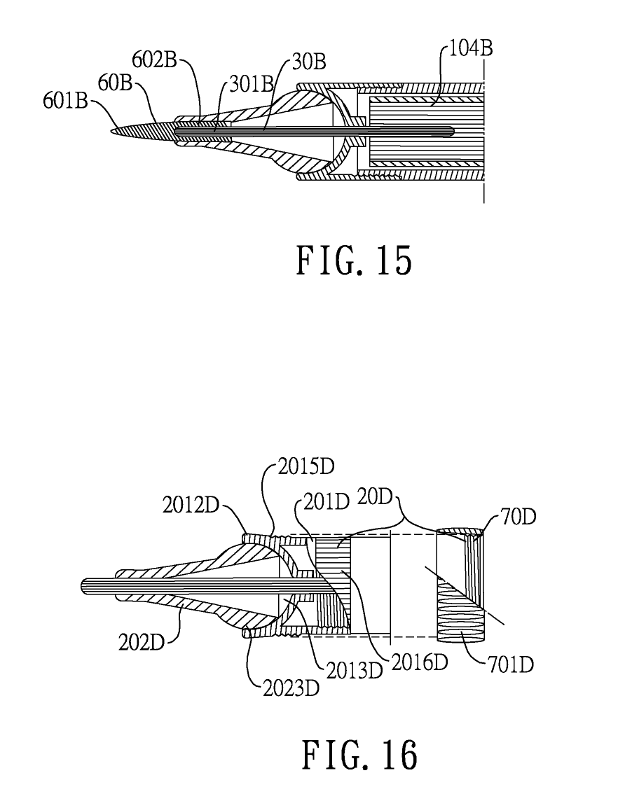

With reference to FIG. 15, in a third embodiment based on the first embodiment, the marker pen of the present invention further comprises a writing tip 60B attached to the writing part 30B to provide different writing effects. The writing tip 60B is made of flexible fibers, which are able to contain ink, such as animal hair fibers, plastic fibers or rubber fibers. The writing tip 60B includes two ends 601B, 602B. One end 602B of the writing tip 60B is connected to the head end 301B of the writing part 30B for leading ink from the ink reservoir to the other end 601B of the writing tip 60B.

With reference to FIG. 16, in a fourth embodiment based on the first embodiment, the first section 201D of the bending assembly 20D further has an external thread 2015D and a nut 70D is screwed onto the external thread 2015D. The second end 2012D of the first section 201D is expanded and an outer periphery of the second end 2012D is greater than an inner periphery of the nut 70D. After the second section 202D is rotated to a suitable angle, screwing the nut 70D toward the second end 2012D of the first section 201D causes the projection 2023D of the second section 202D to be tightly fitted in the recess 2013D of the first section 201D. Thereby, the second section 202D is positioned in place. Further, the nut 70D and the first section 201D are respectively provided with rough peripheral surfaces 701D, 2016D to improve the frictional characteristics for easy operation.

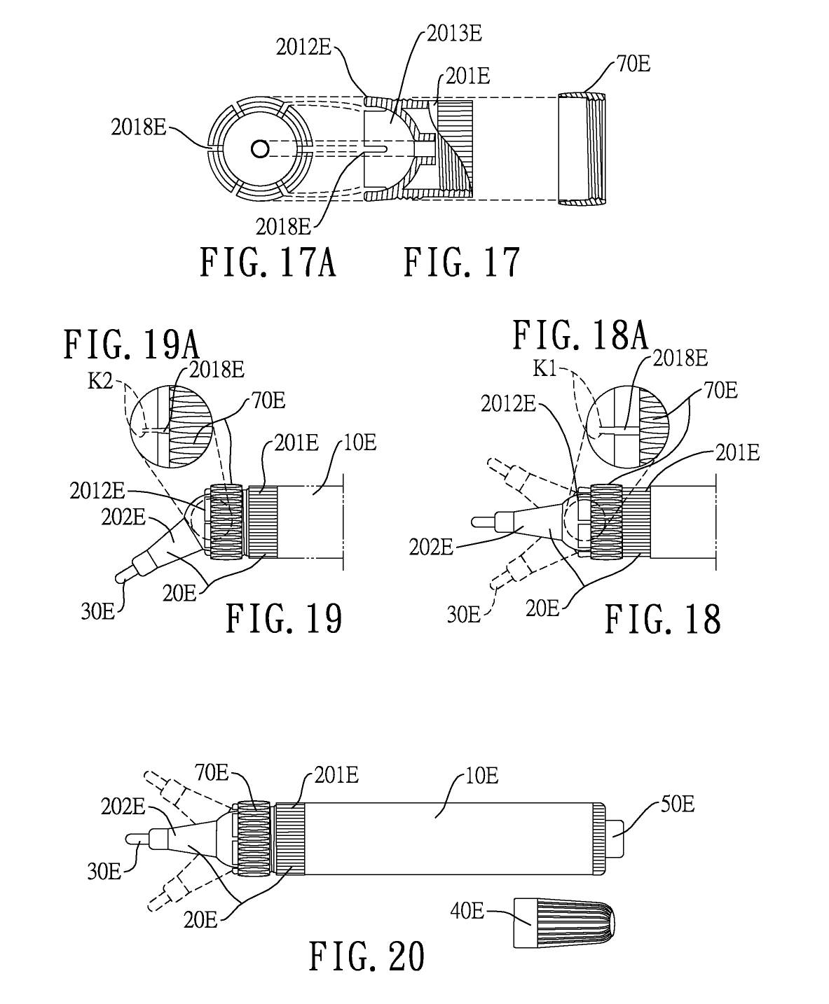

With reference to FIGS. 17 to 20, in a fifth embodiment based on the fourth embodiment, the first section 201E further has multiple notches 2018E respectively formed in the second end 2012E thereof, thus providing that the open end of the recess 2013E has greater flexibility for tightly holding the second section 202E. With reference to FIG. 18A, the notches 2018E are open K1 when the second section 202E is adjusted. With reference to FIG. 19A, the notches 2018E are closed K2 when the nut 70E is screwed toward the second end 2012E of the first section 201E.

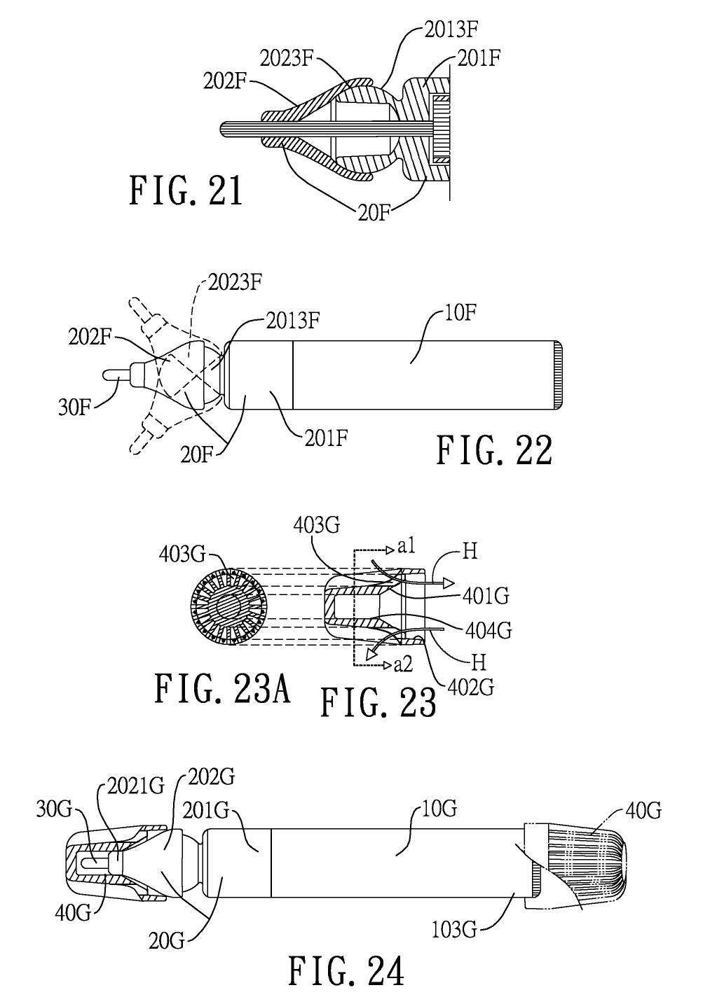

With reference to FIGS. 21 and 22, in a sixth embodiment, the first section 201F of the bending assembly 20F has a curve-shaped projection 2013F and the second section 202F of the bending assembly 20F has a curve-shaped recess 2023F. The projection 2013F of the first section 201F corresponds to and is rotatably mounted in the recess 2023F of the second section 202F. Therefore, the angle between the penholder 10F and the writing part 30F can be adjusted by rotating the second section 202F relative to the first section 201F.

With reference to FIGS. 23 and 24, in a seventh embodiment, the pen cap 40G further includes multiple ventilation holes 403G for allowing air H to flow therethrough so as to avoid choking hazards for children who eat the pen cap 40G by mistake. The ventilation holes 403G communicate with the open portion 402G and the middle portion 401G of the receiving space of the pen cap 40G but do not communicate with the closed portion 404G of the receiving space, thus preventing the writing part 30G from drying out when placed within the closed portion 404G of the receiving space of the pen cap 40G Besides, the pen cap 40G can also be capped on the second end 103G of the tube of the penholder 10G.

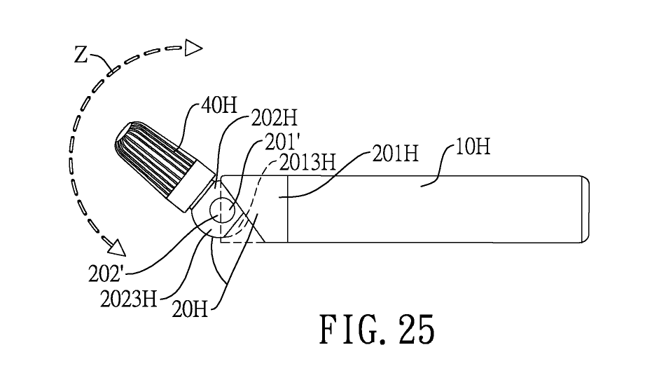

With reference to FIG. 25, in an eighth embodiment based on the first embodiment, a limit structure is mounted between the first section 201H and the second section 202H of the bending assembly 20H to limit the rotation of the second section 202H relative to the first section 201H. The limit structure may include flat surfaces 201′, 202′ respectively formed on sides of the recess 2013H of the first section 201H and sides of the projection 2023H of the second section 202H. The flat surfaces 201′ of the first section 201H correspond to the flat surfaces 202′ of the second section 202H. Thereby, the second section 202H can only be rotated in two-dimensional space relative to the first section 201H, as indicated by arrows Z. On the other hand, the limit structure may include non-circular (e.g. oval) shapes respectively formed on sides of the recess 2013H of the first section 201H and sides of the projection 2023H of the second section 202H.

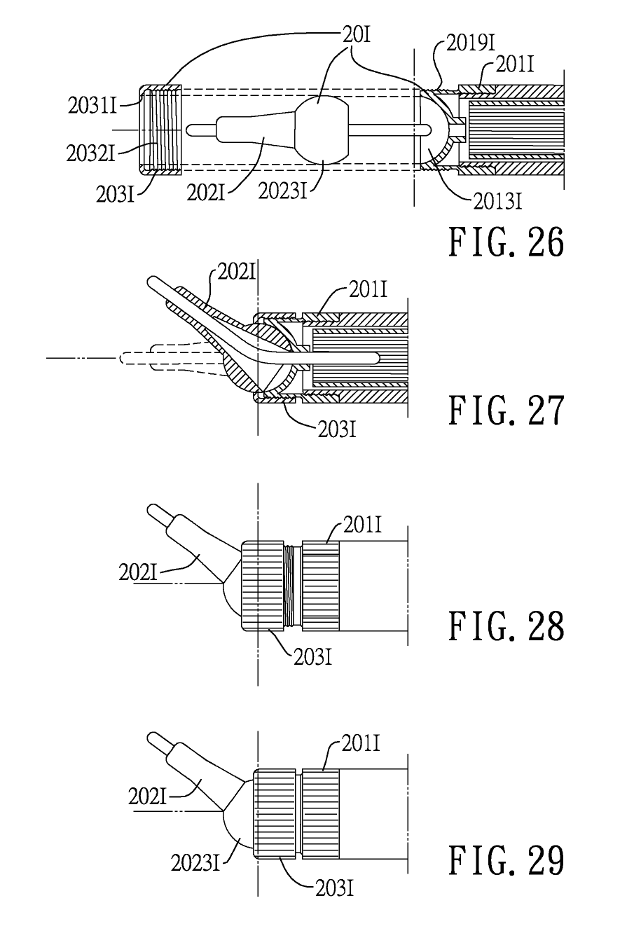

With reference to FIGS. 26 to 29, in a ninth embodiment, the bending assembly 201 further includes a third section 203I. The first section 201I and the second section 202I of the bending assembly 201 are connected via a curve-shaped concave-convex structure. The first section 201I has a recess 2013I and the second section 202I has a projection 2023I. The recess 2013I of the first section 201I is ball-shaped and has a recess open end, a recess closed end, a ball radius and a ball diameter. A distance from the recess open end to the recess closed end is less than the ball radius. A diameter of the recess open end is less than the ball diameter. The projection 2023I of the second section 202I corresponds to and is rotatably mounted in the recess 2013I of the first section 201I. The third section 203I is mounted around the first section 201I to fasten the second section 202I in place. Further, the first section 201I has an external thread 2019I. The third section 203I is hollow and has an inner diameter, an open end 2031I and an internal thread 2032I. A diameter of the open end 2031I of the third section 203I is less than the inner diameter of the third section 203I and is also less than the diameter of the projection 2023I of the second section 202I. The internal thread 2032I of the third section 203I is screwed onto the external thread 2019I of the first section 201I.

With reference to FIG. 28, when it is desired to adjust the bending angle, the third section 203I is screwed away from the first section 201I so that the second section 202I can be rotated freely relative to the first section 201I. With reference to FIG. 29, after the second section 202I is adjusted to a suitable angle, the third section 203I is screwed toward the first section 201I to make the open end 2032I of the third section 203I abut the projection 2023I of the second section 202I. With the third section 203I, efficient production and assembly of the bending assembly 20I is achieved.

The bending assembly 20 may include an adjustable bending angle as described in the foregoing embodiments or may include a non-adjustable angle as described in the following embodiments.

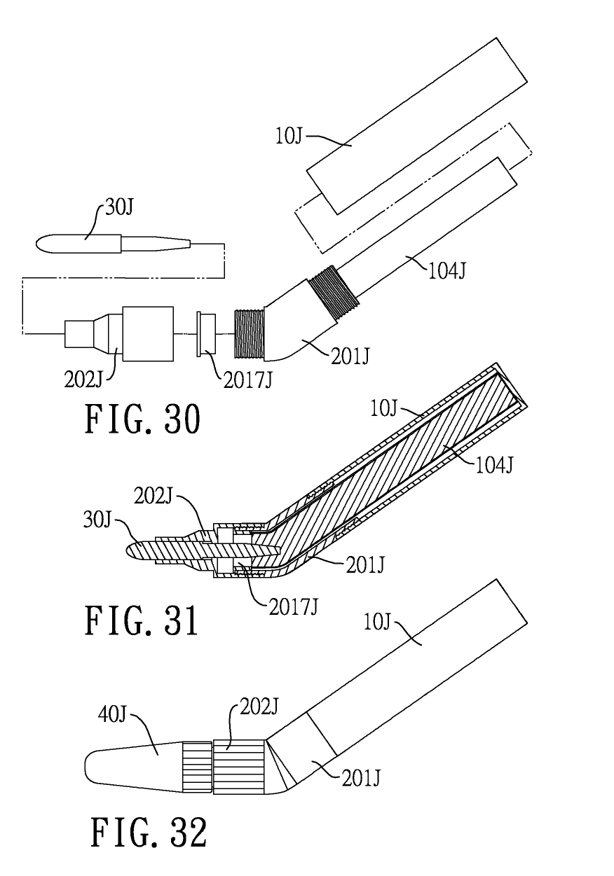

With reference to FIGS. 30 to 32, in a tenth embodiment, the bending angle may be an obtuse angle formed by bending the first section 201J as shown or may be formed by bending the second section 202J. The first section 201J has an external thread adjacent to the second section 202J. The second section 202J has an internal thread screwed onto the external thread of the first section 201J. A blocking part 2017J is mounted in an end of the first section 201J. The blocking part 2017J may be a ring as shown or may include protrusions integrally formed on an inner surface of the first section 201J. The ink reservoir of the penholder 10J is a fiber bunch 104J. An end of the fiber bunch 104J is inserted in the first section 201J from the other end of the first section 201J and abuts the blocking part 2017J of the first section 201J. The writing part 30J is mounted through the first and second sections 201J, 202J and is inserted in the fiber bunch 104J. Further, the penholder 10J, the first section 201J and the second section 202J are circular in cross section.

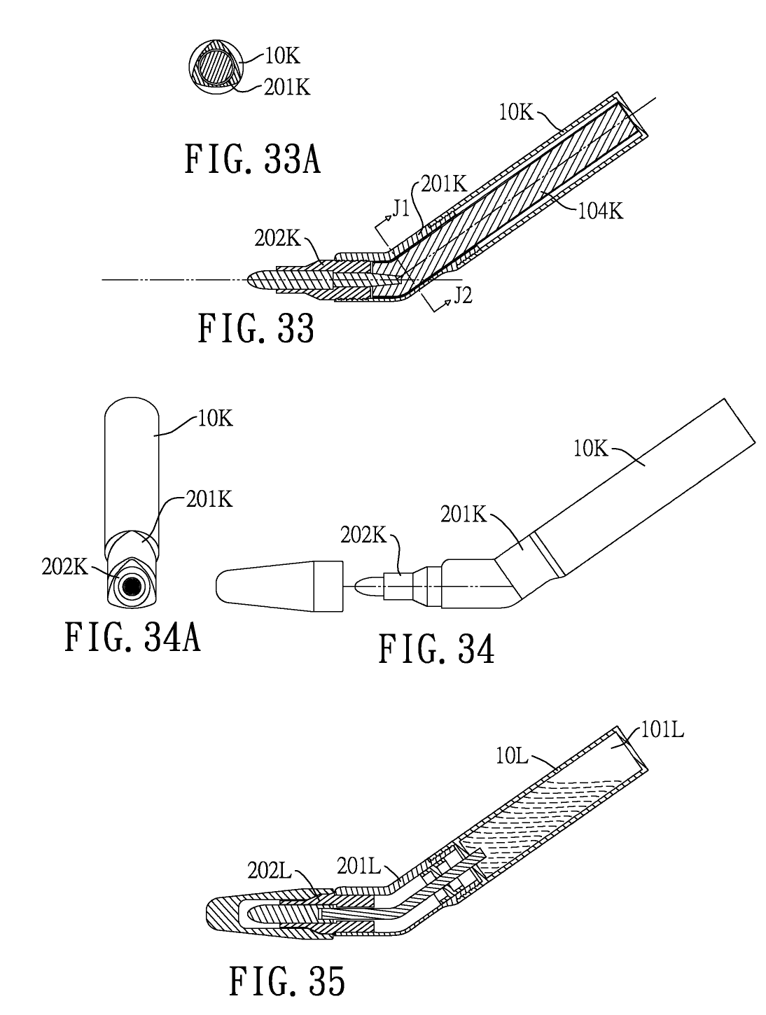

With reference to FIGS. 33 and 34, in an eleventh embodiment, the first section 201K is triangular in cross section, is bent to form the bending angle and has two portions. One of the portions of the first section 201K is connected to the second section 202K. The other portion of the first section 201K is connected the penholder 10K and is adapted for holding by the user. The triangular portion of the first section 201K allows the user's thumb and forefinger to be respectively placed on two sides thereof and allows the user's middle finger to abut the other side thereof, thus the marker pen can be conveniently held in the user's hand. Further, the first section 201K has an internal thread adjacent to the second section 202K. The second section 202K has an external thread screwed into the internal thread of the first section 201K. The ink reservoir of the penholder 10K is a fiber bunch 104K inserted in the first section 201K and abutting the second section 202K.

With reference to FIG. 35, in a twelfth embodiment, the ink reservoir of the penholder 10L is a space defined in the hollow interior 101K of the tube of the penholder 10L. That is, the tube and the ink reservoir are integrally formed as one-piece. The first section 201L and the second section 202L are connected by tightly inserting the first section 201L in the second section 202L.

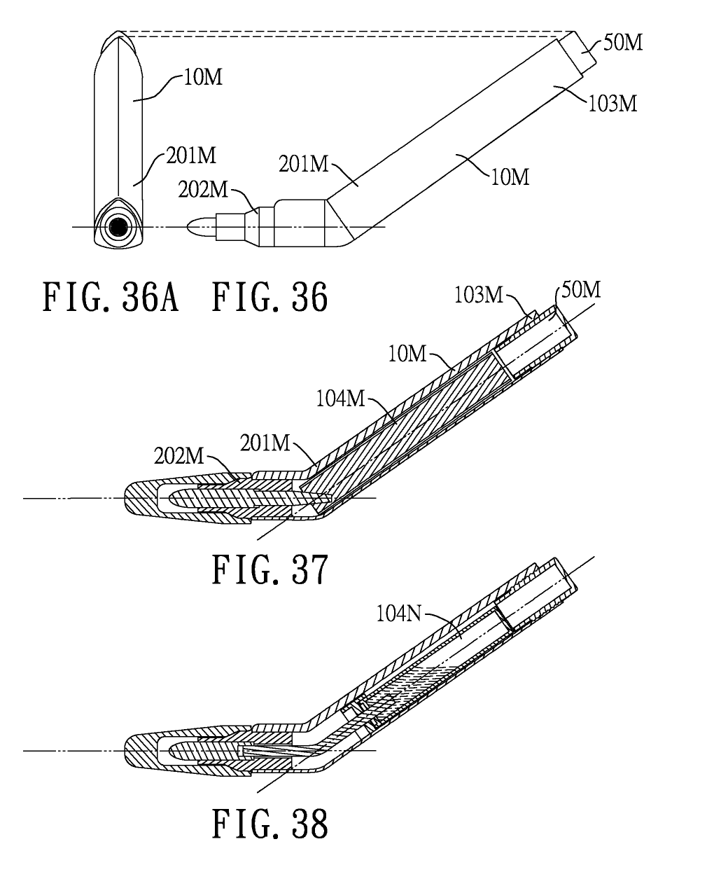

With reference to FIGS. 36 and 37, in a thirteenth embodiment, the penholder 10M and the first section 201M are triangular in cross section. The first section 201M is bent to form the bending angle and has two portions. One of the portions of the first section 201M is connected to the second section 202M. The other portion of the first section 201M is integrally formed as one-piece with the tube of the penholder 10M and is held by the user. The second end 103M of the tube of the penholder 10M is an open end on which an end cover 50M is mounted. The ink reservoir of the penholder 10M may be a fiber bunch 104M as shown in FIG. 37 or may be an ink cartridge 104N as shown in FIG. 38.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A marker pen comprising:
a penholder;
a bending assembly mounted on the penholder and including
a bending angle; and
a first section and a second section connected with each other and the first section attached to the penholder; and
a writing part made of fibers, being able to contain ink, mounted through the bending assembly and inserted in the penholder.

2. The marker pen as claimed in claim 1, wherein
the penholder includes
a tube having a hollow interior; and
an ink reservoir disposed in the hollow interior of the tube; and
the writing part is connected to the ink reservoir of the penholder.

3. The marker pen as claimed in claim 1, wherein the first section and the second section of the bending assembly are connected via a curve-shaped concave-convex structure.

4. The marker pen as claimed in claim 3, wherein the concave-convex structure has
a recess being ball-shaped and having a recess open end, a recess closed end, a ball radius and a ball diameter, a distance from the recess open end to the recess closed end being greater than the ball radius and a diameter of the recess open end being less than the ball diameter; and
a projection being ball-shaped and corresponding to and rotatably mounted in the recess.

5. The marker pen as claimed in claim 4 further having a limit structure mounted between the first section and the second section of the bending assembly.

6. The marker pen as claimed in claim 3, wherein the first section of the bending assembly has
a recess formed in an end of the first section; and
an external thread on which a nut is screwed, an inner periphery of the nut being less than an outer periphery of the end of the first section.

7. The marker pen as claimed in claim 6, wherein the first section of the bending assembly further has multiple notches respectively formed in the end thereof.

8. The marker pen as claimed in claim 3, wherein
the first section of the bending assembly has a recess being ball-shaped and having a recess open end, a recess closed end, a ball radius and a ball diameter, a distance from the recess open end to the recess closed end being less than the ball radius and a diameter of the recess open end being less than the ball diameter;
the second section of the bending assembly has a projection being ball-shaped and corresponding to and rotatably mounted in the recess of the first section; and
the bending assembly further includes a third section mounted around the first section to fasten the second section in place.

9. The marker pen as claimed in claim 1, wherein the writing part is elongated and includes
a head end protruding out of the second section of the bending assembly; and
an insert end inserted in the penholder.

10. The marker pen as claimed in claim 1, wherein
the writing part is elongated and includes
a head end protruding out of the second section of the bending assembly;
an insert end inserted in the penholder; and
the marker pen further comprises a writing tip made of fibers being able to contain ink and attached to the head end of the writing part.

11. The marker pen as claimed in claim 1, wherein the first section of the bending assembly is bent to form the bending angle and has two portions, one of the portions of the first section is connected to the second section and the other portion of the first section is connected to the penholder.

12. The marker pen as claimed in claim 11, wherein the first section of the bending assembly is triangular in cross section.

13. The marker pen as claimed in claim 11, wherein the penholder and the first section of the bending assembly are triangular in cross section.

14. The marker pen as claimed in claim 11, wherein the penholder includes an ink reservoir being a fiber bunch.

15. The marker pen as claimed in claim 11, wherein the penholder includes an ink reservoir being an ink cartridge.

16. The marker pen as claimed in claim 11, wherein
the penholder includes
a tube having an open end on which an end cover is mounted; and
the first section of the bending assembly is integrally formed as one-piece with the tube of the penholder.

17. The marker pen as claimed in claim 1, wherein the penholder includes
a tube having a hollow interior; and
an ink reservoir being a space defined in the hollow interior of the tube.

18. The marker pen as claimed in claim 11, wherein the penholder includes
a tube having a hollow interior; and
an ink reservoir being a space defined in the hollow interior of the tube.
